(19) United States
(12) Patent Application Publication
(10) Pub. No.: US 2023/0147628 A1
(43) Pub. Date: May 11, 2023

(54) SYSTEMS AND METHODS FOR CYCLING A COMMERCIAL APPLIANCE

(71) Applicant: Haier US Appliance Solutions, Inc., Wilmington, DE (US)

(72) Inventors: Ryan James Scheckelhoff, Louisville, KY (US); Jason Fuchs, Louisville, KY (US)

(21) Appl. No.: 17/522,199

(22) Filed: Nov. 9, 2021

(51) Int. Cl. G06Q 20/18; D06F 34/28; D06F 34/04; G06Q 20/40

(52) U.S. Cl. CPC G06Q 20/18; D06F 34/28; D06F 34/04; G06Q 20/409

(57) ABSTRACT

A method for operating a commercial appliance, includes activating the commercial appliance. The commercial appliance is configured such that initiation of operating cycles of the commercial appliance does not require a payment authorization after activating the commercial appliance. The method also includes converting the commercial appliance. The commercial appliance is configured such that initiation of subsequent operating cycles of the commercial appliance requires the payment authorization after converting the commercial appliance.

### FIELD OF THE INVENTION

The present subject matter relates generally to commercial appliances, such as commercial laundry appliances.

### BACKGROUND OF THE INVENTION

Commercial appliances generally require payment prior to initiating operating cycles of the commercial appliances. For example, commercial washing machine appliances require payment prior to washing articles, and commercial dryer appliances require payment prior to drying articles. Thus, users of commercial appliances are generally authorized to run operating cycle only after payment.

The payment requirement for commercial appliances can cause problems. For example, payment is required for lab testing of commercial appliances during production. As another example, payment is required to test commercial appliances after installation. Requiring payment prior to testing commercial appliances is inconvenient to lab technicians during production and installers during installation.

### BRIEF DESCRIPTION OF THE INVENTION

Advantages of the invention will be set forth in part in the following description, or may be apparent from the description, or may be learned through practice of the invention.

In an example embodiment, a method for operating a commercial appliance includes, after the commercial appliance is installed at a location, initiating an operating cycle of the commercial appliance in response to a user input without requiring a payment authorization, converting the commercial appliance to require the payment authorization for subsequent operating cycles of the commercial appliance, and initiating another operating cycle of the commercial appliance in response to the payment authorization.

In another example embodiment, a method for operating a commercial appliance includes activating the commercial appliance. The commercial appliance is configured such that initiation of operating cycles of the commercial appliance does not require a payment authorization after activating the commercial appliance. The method also includes converting the commercial appliance. The commercial appliance is configured such that initiation of subsequent operating cycles of the commercial appliance requires the payment authorization after converting the commercial appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a dryer appliance according to an example embodiment of the present disclosure.

FIG. 2 is a perspective view of the example dryer appliance of FIG. 1 with portions of a cabinet of the exemplary dryer appliance removed to reveal various components of the example dryer appliance.

FIG. 3 illustrates a method for a method for operating a dryer appliance according to an example embodiment of the present disclosure.

FIG. 4 illustrates a method for a method for operating a dryer appliance according to another example embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

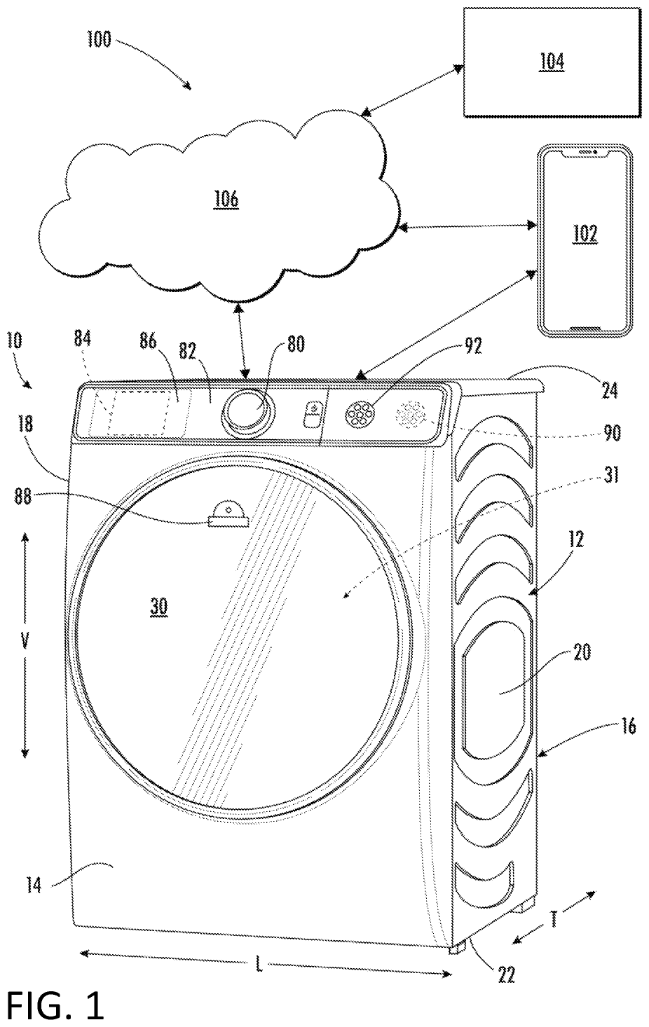

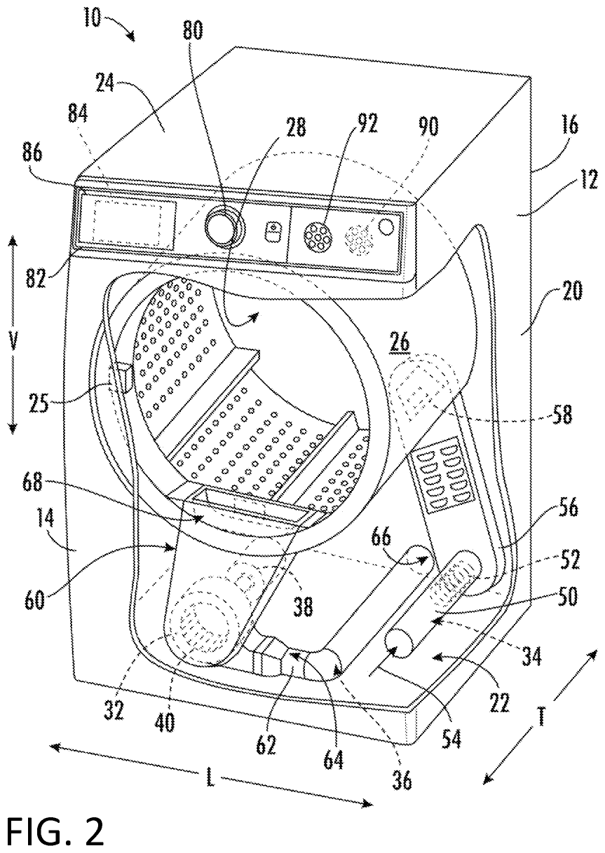

FIG. 1 illustrates a dryer appliance 10 according to an exemplary embodiment of the present subject matter. FIG. 2 provides another perspective view of dryer appliance 10 with a portion of a housing or cabinet 12 of dryer appliance 10 removed in order to show certain components of dryer appliance 10. While described in the context of a specific embodiment of a dryer appliance, using the teachings disclosed herein it will be understood that dryer appliance 10 is provided by way of example only. Other commercial appliances, including alternative laundry appliances, front or top-loaded washer appliances, or combination washer/dryer appliances having different appearances and different features may also be utilized with the present subject matter as well.

Dryer appliance 10 may be configured as a commercial appliance. Thus, e.g., a user of dryer appliance 10 may be required to pay for usage of dryer appliance 10 prior starting an operating cycle of dryer appliance 10, such as a drying cycle. For instance, dryer appliance 10 may include a cash-based operating system that requires a user to input cash or coins into dryer appliance 10 before beginning the operating cycle. As another example, dryer appliance 10 may configured to accept payment via a non-cash operating system that requires a user to electronically provide payment before beginning the operating cycle. Thus, e.g., dryer appliance 10 may be configured to accept payment via PayPal®, Venmo®, a credit card, a debit card, etc. As a specific example, dryer appliance 10 may be configured to implement the payment management system described in U.S. Patent Publication No. 2020/0082659, which is hereby incorporated by reference for all purposes. When dryer appliance 10 is configured as a commercial appliance, a user of dryer appliance 10 may thus pay for usage of dryer appliance 10 with cash and/or electronically prior to starting an operating cycle of dryer appliance 10.

Dryer appliance 10 defines a vertical direction V, a lateral direction L, and a transverse direction T. The vertical direction V, lateral direction L, and transverse direction T are mutually perpendicular and form an orthogonal direction system. Cabinet 12 includes a front panel 14 and a rear panel 16 spaced apart along the transverse direction T, a first side panel 18 and a second side panel 20 spaced apart along the lateral direction L, and a bottom panel 22 and a top cover 24 spaced apart along the vertical direction V. Within cabinet 12 is a container or drum 26 which defines a chamber 28 for receipt of articles, e.g., clothing, linen, etc., for drying. Drum 26 extends between a front portion and a back portion, e.g., along the transverse direction T. In example embodiments, drum 26 is rotatable, e.g., about an axis that is parallel to the transverse direction T, within cabinet 12. Rotation of drum 26 is driven by drum motor 27. A door 30 is rotatably mounted to cabinet 12 for providing selective access to drum 26.

As best shown in FIG. 2, an air handler 32, such as a blower or fan, may be provided to motivate an airflow (not shown) through an entrance air passage 34 and an air exhaust passage 36. Specifically, air handler 32 may include a motor 38 which may be in mechanical communication with a blower fan 40, such that motor 38 rotates blower fan 40. Air handler 32 is configured for drawing air through chamber 28 of drum 26, e.g., in order to dry articles located therein, as discussed in greater detail below. In alternative example embodiments, dryer appliance 10 may include an additional motor (not shown) for rotating fan 40 of air handler 32 independently of drum 26.

Drum 26 may be configured to receive heated air that has been heated by a heating assembly 50, e.g., in order to dry damp articles disposed within chamber 28 of drum 26. Heating assembly 50 includes a heater 52 that is in thermal communication with chamber 28. For instance, heater 52 may include one or more electrical resistance heating elements or gas burners, for heating air being flowed to chamber 28. As discussed above, during operation of dryer appliance 10, motor 38 rotates fan 40 of air handler 32 such that air handler 32 draws air through chamber 28 of drum 26. In particular, ambient air enters an air entrance passage defined by heating assembly 50 via an entrance 54 due to air handler 32 urging such ambient air into entrance 54. Such ambient air is heated within heating assembly 50 and exits heating assembly 50 as heated air. Air handler 32 draws such heated air through an air entrance passage 34, including inlet duct 56, to drum 26. The heated air enters drum 26 through an outlet 58 of inlet duct 56 positioned at a rear wall of drum 26.

Within chamber 28, the heated air may remove moisture, e.g., from damp articles disposed within chamber 28. This internal air flows in turn from chamber 28 through an outlet assembly positioned within cabinet 12. The outlet assembly generally defines an air exhaust passage 36 and includes a trap duct 60, air handler 32, and an exhaust conduit 62. Exhaust conduit 62 is in fluid communication with trap duct 60 via air handler 32. More specifically, exhaust conduit 62 extends between an exhaust inlet 64 and an exhaust outlet 66. According to the illustrated embodiment, exhaust inlet 64 is positioned downstream of and fluidly coupled to air handler 32, and exhaust outlet 66 is defined in rear panel 16 of cabinet 12. During a dry cycle, internal air flows from chamber 28 through trap duct 60 to air handler 32, e.g., as an outlet flow portion of airflow. As shown, air further flows through air handler 32 and to exhaust conduit 62.

The internal air is exhausted from dryer appliance 10 via exhaust conduit 62. In some embodiments, an external duct (not shown) is provided in fluid communication with exhaust conduit 62. For instance, the external duct may be attached (e.g., directly or indirectly attached) to cabinet 12 at rear panel 16. Any suitable connector (e.g., collar, clamp, etc.) may join the external duct to exhaust conduit 62. In residential environments, the external duct may be in fluid communication with an outdoor environment (e.g., outside of a home or building in which dryer appliance 10 is installed). During a dry cycle, internal air may thus flow from exhaust conduit 62 and through the external duct before being exhausted to the outdoor environment.

In exemplary embodiments, trap duct 60 may include a filter portion 68 which includes a screen filter or other suitable device for removing lint and other particulates as internal air is drawn out of chamber 28. The internal air is drawn through filter portion 68 by air handler 32 before being passed through exhaust conduit 62. After the clothing articles have been dried (or a drying cycle is otherwise completed), the clothing articles are removed from drum 26, e.g., by accessing chamber 28 by opening door 30. The filter portion 68 may further be removable such that a user may collect and dispose of collected lint between drying cycles.

One or more selector inputs 80, such as knobs, buttons, touchscreen interfaces, etc., may be provided on a front control panel 82 and may be in communication with a processing device or controller 84. Signals generated in controller 84 operate motor 38, heating assembly 50, and other system components in response to the position of selector inputs 80. Additionally, a display 86, such as an indicator light or a screen, may be provided on front control panel 82. Display 86 may be in communication with controller 84 and may display information in response to signals from controller 84. Selector inputs 80 and display 86 may be collectively referred to herein as a user interface.

As used herein, “processing device” or “controller” may refer to one or more microprocessors or semiconductor devices and is not restricted necessarily to a single element. The processing device may be programmed to operate dryer appliance 10. The processing device may include, or be associated with, one or more memory elements (e.g., non-transitory storage media). In some such embodiments, the memory elements include electrically erasable, programmable read only memory (EEPROM). Generally, the memory elements may store information accessible processing device, including instructions that may be executed by processing device. Optionally, the instructions may be software or any set of instructions and/or data that when executed by the processing device, cause the processing device to perform operations. For certain embodiments, the instructions include a software package configured to operate dryer appliance 10 and execute certain cycles or operating modes.

In addition, referring again to FIG. 1, dryer appliance 10 may generally include an external communication system 100 which is configured for enabling the user to interact with dryer appliance 10 using a remote device 102. Specifically, according to an exemplary embodiment, external communication system 100 is configured for enabling communication between a user, an appliance, and a remote server 104. According to exemplary embodiments, dryer appliance 10 may communicate with a remote device 102 either directly (e.g., through a local area network (LAN), Wi-Fi, Bluetooth, etc.) or indirectly (e.g., via a network 106), as well as with remote server 104, e.g., to receive notifications, provide confirmations, input operational data, transmit messages, etc.

In general, remote device 102 may be any suitable device for providing and/or receiving communications or commands from a user. In this regard, remote device 102 may include, for example, a personal phone, a tablet, a laptop computer, or another mobile device. In addition, or alternatively, communication between the appliance and the user may be achieved directly through an appliance control panel (e.g., control panel 160). In general, network 106 may be any type of communication network. For example, network 106 may include one or more of a wireless network, a wired network, a personal area network, a local area network, a wide area network, the internet, a cellular network, etc. In general, communication with the network may use any of a variety of communication protocols (e.g., TCP/IP, HTTP, SMTP, FTP), encodings or formats (e.g. HTML, XML), and/or protection schemes (e.g., VPN, secure HTTP, SSL).

External communication system 100 is described herein according to an exemplary embodiment of the present subject matter. However, it should be appreciated that the exemplary functions and configurations of external communication system 100 provided herein are used only as examples to facilitate description of aspects of the present subject matter. System configurations may vary, other communication devices may be used to communicate directly or indirectly with one or more appliances, other communication protocols and steps may be implemented, etc. These variations and modifications are contemplated as within the scope of the present subject matter.

In some embodiments, dryer appliance 10 also includes one or more sensors that may be used to facilitate improved operation of dryer appliance. For example, dryer appliance 10 may include one or more temperature sensors which are generally operable to measure internal temperatures in dryer appliance 10. In some embodiments, controller 84 is configured to vary operation profiles of heating assembly 50 based on one or more temperatures detected by the temperature sensors. Dryer appliance 10 may further include a camera 88, e.g., on a window 31 of door 30, that is generally positioned and configured for obtaining images of at least a portion of chamber 28 of dryer appliance 10. Dryer appliance 10 may further include an air flow indicator 90 with an air flow indicator body 92.

While described in the context of a specific embodiment of dryer appliance 10, using the teachings disclosed herein it will be understood that dryer appliance 10 is provided by way of example only. Other commercial appliances, such as dryer appliances, having different configurations, different appearances, and/or different features may also be utilized with the present subject matter as well. For example, the present subject matter may be employed in vented dryer appliances utilizing gas or electric heaters or heat pump-based dryer appliances that circulate air in a closed loop. Other exemplary commercial appliances may include, for example, combination washer/dryer appliances.

Now that the construction of dryer appliance 10 and the configuration of controller 84 according to exemplary embodiments have been presented, exemplary methods of operating a dryer appliance will be described. Although the discussion below refers to the exemplary methods of operating dryer appliance 10, one skilled in the art will appreciate that the exemplary methods are applicable to the operation of a variety of other laundry appliances. In exemplary embodiments, the various method steps as disclosed herein may be performed by controller 84, by a separate, dedicated controller, by remote server 104, or combinations thereof.

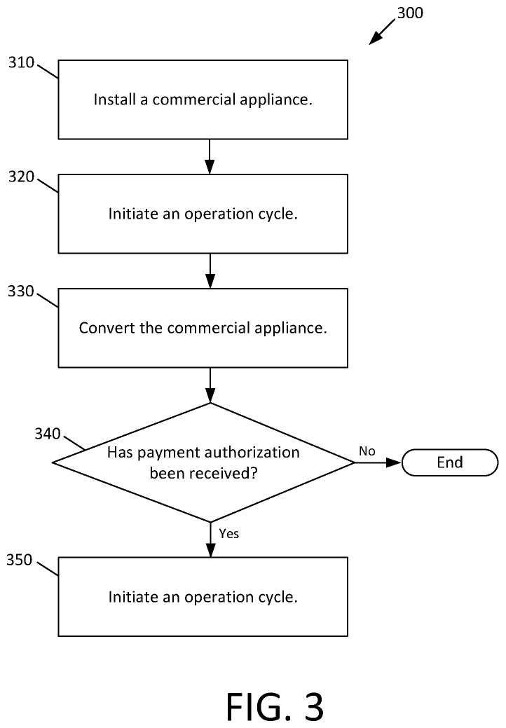

Referring generally to FIG. 3, a method 300 of operating a commercial appliance, such as dryer appliance 10, is provided. Method 300 may be implemented on controller 84 and/or remote server 104. As discussed in greater detail below, method 300 may assist with improving operation of dryer appliance 10. Method 300 may assist with allowing operation of a commercial appliance without requiring payment prior to implementing an operating cycle and subsequently converting the commercial appliance to require payment prior to implementing an operating cycle. Thus, e.g., the commercial appliance may initially operate in a manner similar to residential appliances and then reconfigure to require payment prior to operating. Method 300 may assist with laboratory testing of the commercial appliance and/or testing after installation of the commercial appliance. Moreover, method 300 may assist a lab technician and/or installer with testing of the commercial appliance without inconveniently requiring payment and then subsequently convert to require payment prior to implementing an operating cycle in order to advantageously generate revenue from the commercial appliance.

According to exemplary embodiments, at 310, method 300 includes installing a commercial appliance, such as dryer appliance 10, at a location. For example, an installer may deliver dryer appliance 10 to a location, such as an apartment complex, laundromat, dorm, etc. During the installation, an installer may, e.g., hook up dryer appliance 10 to an electrical circuit and/or a vent duct.

At 320, after the commercial appliance is installed at the location in 310, an operating cycle of the commercial appliance may be initiated in response to a user input without requiring a payment authorization. For example, the installer of dryer appliance 10 may utilize selector inputs 80 to request controller 84 initiate a drying cycle of dryer appliance 10 at 320 without the installer of dryer appliance 10 submitting payment prior to the drying cycle starting. The installer of dryer appliance 10 may thus test the dryer appliance 10 at 320 to insure proper installation and/or operation of dryer appliance 10. Moreover, the installer of dryer appliance 10 may test the installation and/or operation of dryer appliance 10 without inconveniently being required to pay for operation of dryer appliance 10.

At 330, the commercial appliance may be converted to require payment authorization for subsequent operating cycles of the commercial appliance. For example, after testing the installation and/or operation of dryer appliance 10 at 320, the installer may request controller 84 convert dryer appliance 10 to require payment authorization for subsequent operating cycles of dryer appliance 10. As another example, an owner of dryer appliance 10 may request controller 84 convert dryer appliance 10 to require payment authorization for subsequent operating cycles of dryer appliance 10.

Converting the commercial appliance to require the payment authorization at 330 may include converting the commercial appliance to require the payment authorization in response to a conversion trigger. The conversion trigger may be various actions. For example, the conversion trigger may include connecting a network adapter of dryer appliance 10 to remote server 104 via network 106. For example, after 320, the installer or an owner of dryer appliance 10 may connect dryer appliance 10 to network 106. In response to connecting dryer appliance 10 to network 106, controller 84 may convert dryer appliance 10 to require payment authorization for subsequent operating cycles of dryer appliance 10. Thus, controller 84 may automatically convert dryer appliance 10 to require payment authorization for subsequent operating cycles of dryer appliance 10 in response to connecting dryer appliance 10 to network 106. As another example, the conversion trigger may include receiving data corresponding to a conversion command from remote server 104 via network 106. Thus, e.g., an owner of dryer appliance 10 may utilize remote device 102 (e.g., on an app, owner's portal, etc.) to request the conversion, remote device 102 may communicate the request for conversion to remote server 104 via network 106, and remote server 104 may communicate the request for conversion to controller 84. In response, controller 84 may convert dryer appliance 10 to require payment authorization for subsequent operating cycles of dryer appliance 10. As another example, the conversion trigger may include receiving a conversion command input from selector inputs 80. Thus, e.g., the installer or the owner of dryer appliance 10 may utilize selector inputs 80 to trigger the conversion command input, and controller 84 may convert dryer appliance 10 to require payment authorization for subsequent operating cycles of dryer appliance 10 in response to receiving the conversion command input from selector inputs 80. The conversion trigger may thus include a key, button, and/or knob sequence on selector inputs 80 for controller 84 to convert dryer appliance 10 to require payment authorization for subsequent operating cycles of dryer appliance 10. As another example, the conversion trigger may include receiving a conversion command from a data port of dryer appliance 10. Thus, e.g., the installer of dryer appliance 10 may plug a device into the data port of dryer appliance 10 and command controller 84 to convert dryer appliance 10 to require payment authorization for subsequent operating cycles of dryer appliance 10.

It will be understood that the conversion of the commercial appliance to require the payment authorization at 330 may be permanent. Thus, e.g., the commercial appliance may require the payment authorization for all subsequent operating cycles of the commercial appliance. Thus, the operation of the commercial appliance at 320 for testing purposes may only be permitted for initial testing. Subsequent operation of the commercial appliance after 330 may thus always require payment and thereby generate revenue. Conversion of the commercial appliance back to the mode permitted at 320 may be blocked or prohibited in order to prevent potential bypassing of the payment requirement.

After 330, it may be determined at 340 whether the payment authorization has been received. For example, controller 84 may receive the payment authorization after receipt of cash payment, such as coins or bills, or a non-cash payment, such as a card payment, PayPal®, Venmo®, an app payment, etc. At 350, an operating cycle of the commercial appliance may be initiated in response to the payment authorization. In contrast, the commercial appliance may not initiate the operating cycle if payment authorization is not received at 340.

As may be seen from the above, method 300 may assist with allowing a commercial appliance, such as dryer appliance 10, to operate as a residential unit such that payment authorization is not required to run cycles, e.g., immediately after installation of activation of the commercial appliance. Thus, e.g., when initially built, the commercial appliance may be configured to operate as a residential unit and not require payment authorization to run cycles “out of the box.” When installed in an actual commercial environment, the commercial appliance may converted to operate as a commercial appliance such that payment authorization is not required to run cycles. A conversion trigger, such as connecting to a wireless network, a command received through a network (e.g., from an app, an owner's portal, etc.), a key or knob sequence on a user interface of the commercial appliance, or a command issued through a communication port on the commercial appliance. In such a manner, method 300 may assist with engineering testing and qualification of the commercial appliance as well as appliance install verification and then subsequently be converted for commercial operation to generate revenue.

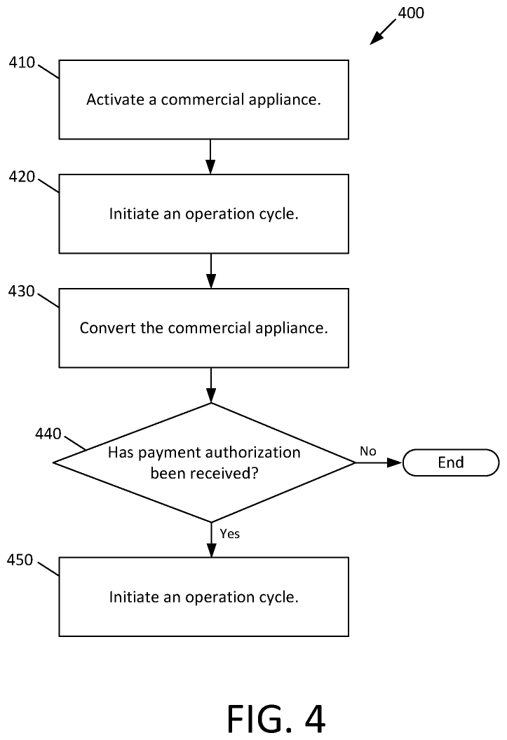

Referring generally to FIG. 4, a method 400 of operating a commercial appliance, such as dryer appliance 10, is provided. Method 400 may be implemented on controller 84 and/or a remote server. As discussed in greater detail below, method 400 may assist with improving operation of dryer appliance 10. Method 400 may assist with allowing operation of a commercial appliance without requiring payment prior to implementing an operating cycle and subsequently converting the commercial appliance to require payment prior to implementing an operating cycle. Thus, e.g., the commercial appliance may initially operate in a manner similar to residential appliances and then reconfigure to require payment prior to operating. Method 400 include similar steps as method 300 (FIG. 3) and such similar steps are not described in greater detail below for the sake of brevity. Rather, the description of method 400 provided below focuses on certain differences between method 400 and method 300.

As shown in FIG. 4, at 410, method 400 includes activating a commercial appliance, such as dryer appliance 10, at a location. For example, an installer may deliver dryer appliance 10 to a location, such as an apartment complex, laundromat, dorm, etc. During the installation, an installer may, e.g., hook up dryer appliance 10 to an electrical circuit and/or a vent duct. As another example, a lab technician may activate dryer appliance 10 after manufacture of dryer appliance 10. The lab technician may connect dryer appliance 10 to an electrical circuit and measurement sensors for monitoring operation of dryer appliance.

The commercial appliance may be configured such that initiation of operating cycles of the commercial appliance does not require a payment authorization after activating the commercial appliance at 410. Thus, at 420, after the commercial appliance is activated, an operating cycle of the commercial appliance may be initiated without requiring a payment authorization. For example, the installer of dryer appliance 10 or the lab technician may utilize selector inputs 80 to request controller 84 initiate a drying cycle of dryer appliance 10 at 420 without submitting payment prior to the drying cycle starting. The installer of dryer appliance 10 or the lab technician may thus test the dryer appliance 10 at 420 to insure proper installation and/or operation of dryer appliance 10. Moreover, the installer of dryer appliance 10 or the lab technician may test the installation and/or operation of dryer appliance 10 without inconveniently being required to pay for operation of dryer appliance 10.

At 430, the commercial appliance may be converted. The commercial appliance may be configured such that initiation of subsequent operating cycles of the commercial appliance requires the payment authorization after converting the commercial appliance. For example, after testing the installation and/or operation of dryer appliance 10 at 420, the installer may request controller 84 convert dryer appliance 10 to require payment authorization for subsequent operating cycles of dryer appliance 10. As another example, an owner of dryer appliance 10 may request controller 84 convert dryer appliance 10 to require payment authorization for subsequent operating cycles of dryer appliance 10.

It will be understood that the conversion of the commercial appliance to require the payment authorization at 430 may be permanent. Thus, e.g., the commercial appliance may require the payment authorization for all subsequent operating cycles of the commercial appliance. Thus, the operation of the commercial appliance at 420 for testing purposes may only be permitted for initial testing. Subsequent operation of the commercial appliance after 430 may thus always require payment and thereby generate revenue. Conversion of the commercial appliance back to the mode permitted at 420 may be blocked or prohibited in order to prevent potential bypassing of the payment requirement.

FIGS. 3 and 4 depict steps performed in a particular order for purposes of illustration and discussion. Those of ordinary skill in the art, using the disclosures provided herein, will understand that the steps of any of the methods discussed herein may be adapted, rearranged, expanded, omitted, or modified in various ways without deviating from the scope of the present disclosure. Moreover, although aspects of methods 300, 400 are explained using dryer appliance 10 as an example, it should be appreciated that these methods may be applied to the operation of any suitable commercial appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for operating a commercial appliance, comprising:
after the commercial appliance is installed at a location, initiating an operating cycle of the commercial appliance in response to a user input without requiring a payment authorization;
converting the commercial appliance to require the payment authorization for subsequent operating cycles of the commercial appliance; and
initiating another operating cycle of the commercial appliance in response to receiving the payment authorization.

2. The method of claim 1, wherein converting the commercial appliance to require the payment authorization comprises converting the commercial appliance to require the payment authorization in response to a conversion trigger.

3. The method of claim 2, wherein the conversion trigger comprises connecting a network adapter of the commercial appliance to a remote server via a network.

4. The method of claim 2, wherein the conversion trigger comprises receiving data corresponding to a conversion command from a remote server via a network.

5. The method of claim 2, wherein the conversion trigger comprises receiving a conversion command input from a user interface on the commercial appliance.

6. The method of claim 2, wherein the conversion trigger comprises receiving data corresponding to a conversion command from a communications port on the commercial appliance.

7. The method of claim 1, wherein the commercial appliance comprises a washing machine appliance or a dryer appliance.

8. A method for operating a commercial appliance, comprising:
activating the commercial appliance, wherein the commercial appliance is configured such that initiation of operating cycles of the commercial appliance does not require a payment authorization after activating the commercial appliance; and
converting the commercial appliance, wherein the commercial appliance is configured such that initiation of subsequent operating cycles of the commercial appliance requires the payment authorization after converting the commercial appliance.

9. The method of claim 8, wherein converting the commercial appliance comprises converting the commercial appliance in response to a conversion trigger.

10. The method of claim 9, wherein the conversion trigger comprises connecting a network adapter of the commercial appliance to a remote server via a network.

11. The method of claim 9, wherein the conversion trigger comprises receiving data corresponding to a conversion command from a remote server via a network.

12. The method of claim 9, wherein the conversion trigger comprises receiving a conversion command input from a user interface on the commercial appliance.

13. The method of claim 9, wherein the conversion trigger comprises receiving data corresponding to a conversion command from a communications port on the commercial appliance.

14. The method of claim 8, wherein the commercial appliance comprises a washing machine appliance or a dryer appliance.

15. The method of claim 1, further comprising testing the commercial appliance without requiring a payment authorization.

16. The method of claim 8, further comprising testing the commercial appliance without requiring a payment authorization.

17. The method of claim 8, wherein activating the commercial appliance occurs after the commercial appliance is installed at a location.
